(19) United States
(12) Patent Application Publication
(10) Pub. No.: US 2025/0390453 A1
(43) Pub. Date: Dec. 25, 2025

(54) DATA PROCESSING METHOD AND APPARATUS

(71) Applicant: Smarter Silicon (Shanghai) Technologies Co., Ltd., Shanghai (CN)

(72) Inventor: Ensong ZHOU, Shanghai (CN)

(21) Appl. No.: 19/245,222

(22) Filed: Jun. 20, 2025

(30) Foreign Application Priority Data
Jun. 21, 2024 (CN) 202410816324.6

(51) Int. Cl. G06F 13/22

(52) U.S. Cl. CPC G06F 13/225

(57) ABSTRACT

A data processing method includes receiving a plurality of pieces of first data using an input port of a current bus, each piece of first data including corresponding weight information, based on a specified unit data amount, splitting each piece of first data into at least one data unit, the unit data amount representing a minimum data amount of a single scheduling of the current bus, based on the weight information corresponding to each piece of first data, determining a corresponding number of data units from each piece of first data as second data corresponding to corresponding first data, and in a next bus scheduling cycle, sequentially sending each piece of second data from the input port of the current bus to a reception target according to a scheduling order.

### CROSS-REFERENCE TO RELATED APPLICATION

The present disclosure claims priority to Chinese Patent Application No. 202410816324.6, filed on Jun. 21, 2024, the entire content of which is incorporated herein by reference.

### TECHNICAL FIELD

The present disclosure relates to the computer technology field and, more particularly, to a data processing method and a data processing apparatus.

### BACKGROUND

A System on Chip (SOC) contains a plurality of functional modules, such as a processor core, a memory controller, a peripheral controller, an accelerator, etc. A certain bus specification is required for efficient communication and data transmission between the plurality of functional modules of the SOC. Therefore, how to optimize a scheduling algorithm used by the bus of the SOC to improve the communication efficiency between the functional modules has become an urgent problem to be solved.

### SUMMARY

An aspect of the present disclosure provides a data processing method. The method includes receiving a plurality of pieces of first data using an input port of a current bus, each piece of first data including corresponding weight information, based on a specified unit data amount, splitting each piece of first data into at least one data unit, the unit data amount representing a minimum data amount of a single scheduling of the current bus, based on the weight information corresponding to each piece of first data, determining a corresponding number of data units from each piece of first data as second data corresponding to corresponding first data, and in a next bus scheduling cycle, sequentially sending each piece of second data from the input port of the current bus to a reception target according to a scheduling order.

An aspect of the present disclosure provides a data processing apparatus, including a reception module, a data splitting module, a first determination module, and a transmission module. The reception module is configured to receive a plurality of first data at an input port of a current bus; each piece of first data has corresponding weight information. The data splitting module is configured to, based on a specified unit data amount, split each piece of first data into at least one data unit, the unit data amount representing a minimum data amount of the current bus in a single scheduling. The first determination module is configured to, based on the weight information corresponding to each piece of first data, determine a corresponding number of data units from each piece of first data as second data corresponding to the corresponding first data. The transmission module is configured to sequentially send each piece of second data to a reception target from the input port of the current bus according to a scheduling order in a next bus scheduling cycle.

An aspect of the present disclosure provides a non-transitory computer-readable storage medium storing a program that, when executed by a processor, causes the processor to receive a plurality of pieces of first data using an input port of a current bus, each piece of first data including corresponding weight information, based on a specified unit data amount, split each piece of first data into at least one data unit, the unit data amount representing a minimum data amount of a single scheduling of the current bus, based on the weight information corresponding to each piece of first data, determine a corresponding number of data units from each piece of first data as second data corresponding to corresponding first data, and in a next bus scheduling cycle, sequentially send each piece of second data from the input port of the current bus to a reception target according to a scheduling order.

### BRIEF DESCRIPTION OF THE DRAWINGS

FIG. 1 illustrates a schematic structural diagram of a bus scheduling architecture.

FIG. 2 illustrates a schematic diagram showing a data scheduling sequence for bus scheduling using a strict priority scheduling algorithm.

FIG. 3 illustrates a schematic flowchart of a data processing method according to some embodiments of the present disclosure.

FIG. 4 illustrates a schematic flowchart of another data processing method according to some embodiments of the present disclosure.

FIG. 5 illustrates a schematic flowchart of another data processing method according to some embodiments of the present disclosure.

FIG. 6 illustrates a schematic flowchart of another data processing method according to some embodiments of the present disclosure.

FIG. 7 illustrates a schematic flowchart of another data processing method according to some embodiments of the present disclosure.

FIG. 8 illustrates a schematic flowchart of another data processing method according to some embodiments of the present disclosure.

FIG. 9 illustrates a schematic diagram of a data scheduling sequence for bus scheduling in a data processing method according to some embodiments of the present disclosure.

FIG. 10 illustrates a schematic diagram of another data scheduling sequence for bus scheduling in a data processing method according to some embodiments of the present disclosure.

FIG. 11 illustrates a schematic flowchart of another data processing method according to some embodiments of the present disclosure.

FIG. 12 illustrates a schematic flowchart of another data processing method according to some embodiments of the present disclosure.

FIG. 13 illustrates a schematic flowchart of bus scheduling in a data processing method according to some embodiments of the present disclosure.

FIG. 14 illustrates a schematic structural diagram of a data processing apparatus according to some embodiments of the present disclosure.

FIG. 15 illustrates a schematic diagram showing hardware of a computer device according to some embodiments of the present disclosure.

### DETAILED DESCRIPTION OF THE EMBODIMENTS

To make the purpose, features, and advantages of the present disclosure clearer, the technical solutions of embodiments of the present disclosure are described in detail below in conjunction with the accompanying drawings of embodiments of the present disclosure. Apparently, the described embodiments are only some embodiments of the present disclosure, and not all embodiments. Based on embodiments of the present disclosure, all other embodiments obtained by those skilled in the art without creative effort shall fall within the scope of the present disclosure.

In the following description, “some embodiments” describe a subset of all possible embodiments. However, “some embodiments” may be the same or different subsets of all possible embodiments and can be combined with each other when there is no conflict.

In the following description, the terms “first/second/third” are merely used to distinguish similar objects and do not imply a specific order of the objects. “first/second/third” may, where permissible, be interchanged in specific sequences or orders to enable embodiments of the present disclosure described here to be implemented in sequences other than those illustrated or described.

Unless otherwise defined, all technical and scientific terms used in the present specification can have the same meanings as commonly understood by those skilled in the art. The terms used herein are solely for the purpose of describing embodiments of the present disclosure and are not intended to limit the present disclosure.

To better understand a data processing method of embodiments of the present disclosure, a bus scheduling solution of the existing technology is described in detail below.

In the existing technology, a bus arbiter usually adopts a strict priority (SP) algorithm to perform data scheduling.

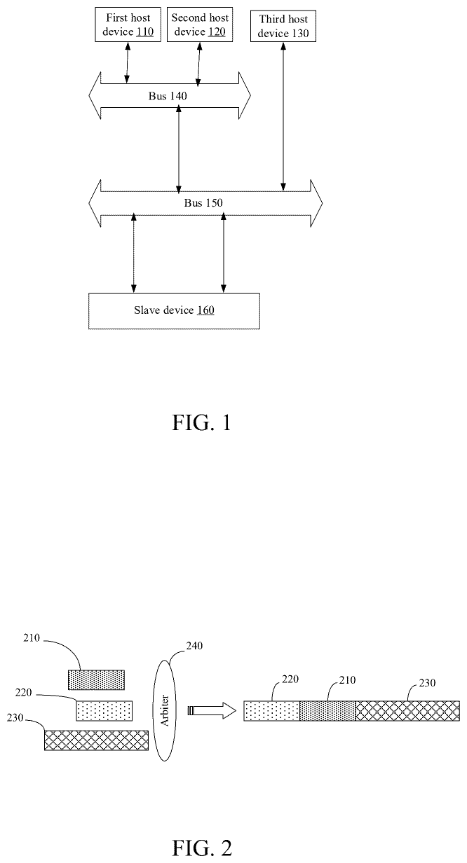

As shown in FIG. 1, in an example of a bus scheduling architecture, data sent by a first host device 110 and a second host device 120 is sent to a slave device 160 through a bus 140 and a bus 150. Data from a third host device 130 is sent to the slave device 160 through the bus 150.

When performing scheduling using the SP scheduling algorithm, and data sent by the first host device 110, data sent by the second host device 120, and data sent by the third host device 130 arrive at an input port of the same bus, a corresponding bus arbiter can perform data scheduling according to arrival time of each piece of data and the corresponding priority.

As shown in FIG. 2, the first host device 110, the second host device 120, and the third host device 130 send data 210, data 220, and data 230 to the current bus, respectively. The priorities corresponding to the data 210, data 220, and data 230 decrease in sequence, and the data 230 arrives at the current bus first, followed by the data 220, and then the data 210. Thus, according to the SP scheduling algorithm, since the data 230 arrives first at the data input port of the current bus, an arbiter 240 starts to schedule the data 230. Although the data 210 and the data 220 with higher priorities have already arrived at the bus input port before the reception of the data 230 is completed, since the SP scheduling algorithm does not support scheduling interruption, the scheduling of the data 230 may need to be finished first, and then the data 210 and the data 220 can be scheduled in sequence.

Meanwhile, when the scheduling of the data 230 is completed, the data 210 and the data 220 have been cached at the input port of the current bus. Thus, when performing scheduling on the data 210 and the data 220, the arbiter 240 can schedule the data 210 first and then schedule the data 220 according to the priority order.

When the bus arbiter 240 schedules the data according to the SP scheduling algorithm, a serious scheduling delay can exist for scheduling the data 210 and the data 220 with the higher priority.

Based on this, the present disclosure provides a data processing method. The method can be performed by the bus arbiter of the computer device. The computer device can include a device having the data processing capability, such as a server, a laptop, a tablet, a desktop, a smartTV, a set-top box, and a mobile device (e.g., mobile phone, portable video player, a personal digital assistant, a dedicated messaging device, and a portable gaming device).

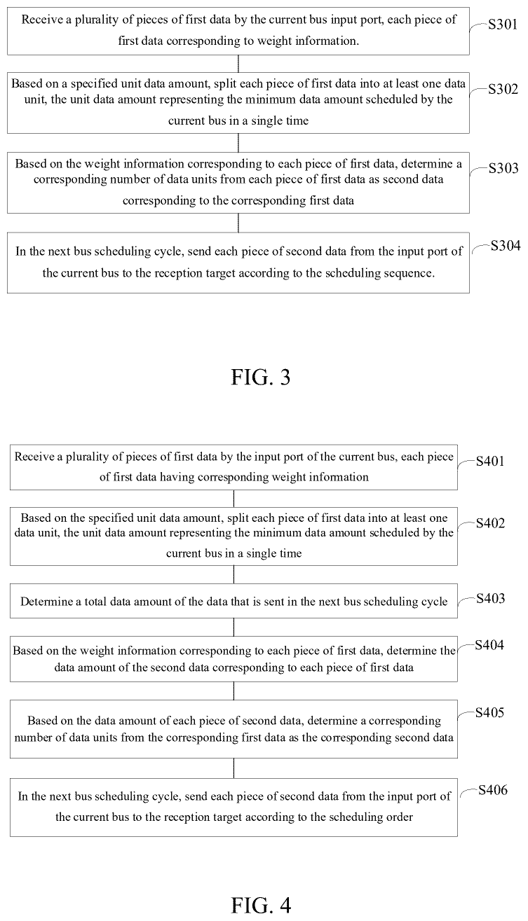

FIG. 3 illustrates a schematic flowchart of a data processing method according to some embodiments of the present disclosure. As shown in FIG. 3, the method includes the following steps S301 to S303.

At S301, a plurality of pieces of first data are received by the current bus input port. Each piece of first data corresponds to weight information.

The current bus can refer to the bus used to perform the data processing method of the present disclosure.

In some embodiments, the current bus can be any type of bus used to perform data scheduling in a computer system.

In some embodiments, the current bus can include a data bus, a control bus, an address bus, an expansion bus, and/or a local bus.

In some embodiments, the first data can be data sent by the same device to the input port of the current bus.

In some embodiments, the first data can be data received by the same input port of the current bus.

In some embodiments, the first data can be used to represent image data, audio data, text data, or any type of data known in the field. For example, the first data can be a frame of image, 1 ms long audio, etc.

In some embodiments, the weight information can refer to a proportion of the data amount of the corresponding the first data that is scheduled and a total data amount that is scheduled within a scheduling cycle of the current bus.

In some embodiments, the weight of the first data can be determined based on a type of host device sending the first data. For example, the weight of the first data sent by the central processing unit (CPU) can be higher than the weight of the first data sent by the graphics processing unit (GPU).

In some embodiments, the weight of the first data can be determined based on the data type of the first data. For example, first data of a protocol type can have a higher priority than first data of a copy type.

In some embodiments, the weight of each piece of first data can be determined based on the current operation scenario of the computer device executing the data processing method of the present disclosure. For example, when the current operation scenario of the computer device is a video playing scenario or a model inference scenario, to provide a smoother video playing effect or a model inference speed for the user, a higher weight can be assigned to the first data sent by the GPU. For another example, when the current operation scenario of the computer device is an audio playing scenario, a higher weight can be assigned to the first data sent by the sound card.

In some embodiments, the input port of the current bus can include a plurality of input sub-ports. Each input sub-port can have a corresponding weight. Then, the weight information corresponding to the first data can be determined based on the weight of the input sub-port corresponding to the first data.

In some embodiments, each input sub-port of the current bus can include corresponding weight information. Thus, after the first data is cached into the corresponding input sub-port, the weight of the input sub-port can be used as the weight corresponding to the cached first data.

In some embodiments, the plurality of input sub-ports can have a preset correspondence with at least one type of first data. Thus, after the first data is cached into the corresponding input sub-port, based on the type of the first data, a corresponding weight can be assigned to the corresponding input sub-port, and the weight of the input sub-port can be used as the weight corresponding to the first data.

In some embodiments, each piece of first data can have corresponding priority information. Thus, the data processing method of the present application can further include determining the weight information corresponding to each piece of first data based on the priority information corresponding to each piece of first data.

In some embodiments, the priority information corresponding to the first data can be determined based on the transmission device sending the first data. For example, a higher priority can be assigned to data sent by a transmission device with a higher control authority.

In some embodiments, the priority information corresponding to the first data can be determined based on the attribute information of the first data. For example, when the attribute information of the first data includes the scheduling cycle corresponding to the first data, a higher priority can be assigned to the first data with a shorter scheduling cycle, and a lower priority can be assigned to the first data with a longer scheduling cycle. For another example, when the attribute information of the first data includes a deadline, a higher priority can be assigned to the first data with a shorter deadline, and a lower priority can be assigned to the first data with a longer deadline.

In some embodiments, the priority information corresponding to the first data can be determined based on the current operation scenario of the computer device executing the data processing method of the present disclosure. For example, when the current operation scenario of the computer device is a video playback scenario, a higher priority can be assigned to the first data related to controlling a video playback speed, video playback resolution, video image frame transmission, etc. For another example, when the current scenario of the computer device is the model inference scenario, a higher priority can be assigned to the first data related to model computation.

In some embodiments, the priority information corresponding to the first data can be determined based on the input port of the current bus configured to receive the first data. That is, the current bus can include a plurality of input ports, and each input port can have corresponding priority information. Then, the priority information corresponding to each input port can be used as the priority information of the first data received by the input port.

In some embodiments, determining the corresponding weight information based on the priority information corresponding to each first data can refer to assigning a higher weight to the first data with higher priority and assigning a lower weight to the first data with lower priority.

In some embodiments, different priority levels can be used to represent different priority information. For example, levels 0 to N can be used to represent priority levels, a larger number can indicate a higher priority, where N>1. Thus, when the weight information corresponding to each first data is determined based on the priority information corresponding to each first data, the weight of the corresponding first data can be determined based on a ratio of the priority level corresponding to each first data to the sum of all the priority levels of the first data.

Thus, determining the corresponding weight information based on the priority information corresponding to each first data can include assigning a higher weight to the first data with a higher priority. Thus, within each scheduling cycle of the current bus, more scheduling resources can be assigned to the first data with a higher priority (i.e., when the priority is higher, a larger data amount is scheduled in each scheduling cycle), which enables a faster response to the first data with a higher priority to complete scheduling earlier.

At S302, based on a specified unit data amount, splitting each piece of first data into at least one data unit. The unit data amount represents the minimum data amount scheduled by the current bus in a single time.

The unit data amount can be a preset minimum data amount for a single schedule of the current bus.

In some embodiments, the size of the unit data amount can be determined based on the bit width of the current bus. When the bit width of the current bus is larger, the unit data amount can be larger. When the bit width of the current bus is smaller, the unit data amount can be smaller. For example, when the bit width of the current bus is 64 bits, the unit data amount can be set to 16 bytes. When the bit width of the current bus is 32 bits, the unit data amount can be set to 8 bytes. In some embodiments, the input port of the current bus can include a plurality of input sub-ports, and each data sub-port can have a corresponding unit data amount. That is, the first data entering different input sub-ports can be split based on different or the same unit data amounts.

Each piece of first data can be split into at least one data unit. That is, the unit data amount can be used as the splitting granularity. Each piece of first data can be split into at least one data unit. For example, when the unit data amount is 16 bytes, the 16 bytes can be used as a unit to split the first data into at least one data unit.

In some embodiments, each piece of data unit can have corresponding identification information. The identification information can be used to indicate a mapping relationship between a corresponding data unit and corresponding first data, and can also indicate the position information of the corresponding data unit within the corresponding first data.

Thus, by splitting each piece of first data into small granularity data units, the current bus can schedule each piece of first data by using the data unit as a unit when performing data scheduling. The current bus can schedule some data units of a plurality of pieces of first data simultaneously within a single bus scheduling cycle. Thus, the response frequency to the plurality of pieces of first data can be increased to reduce the data scheduling delay.

At S303, based on the weight information corresponding to each piece of first data, a corresponding number of data units can be determined from each piece of first data as second data corresponding to the corresponding first data.

Based on the weight corresponding to the first data, the scheduling resource (i.e., the schedule data amount) occupied by the first data in the next bus scheduling cycle can be determined to determine the at least one data unit that is scheduled in the next bus scheduling cycle from the at least one data unit corresponding to the first data.

For example, based on the weight information corresponding to the first data, the data amount that can be scheduled for the first data in the next bus scheduling cycle can be determined to be 160 bytes, and the data amount of each piece of data unit of the first data can be determined to be16 bytes. Then, 10 data units of the first data can be used as the data that can be scheduled in the next bus scheduling cycle, i.e., the second data corresponding to the first data.

At S304, in the next bus scheduling cycle, each piece of second data is sent from the input port of the current bus to the reception target according to the scheduling sequence.

After determining the second data corresponding to each piece of first data, when the next bus scheduling cycle arrives, at least one piece of second data is sent to the reception target according to the scheduling order.

In some embodiments, the reception target can include a next-level bus of the current bus, or a slave device corresponding to the host device sending the first data.

In some embodiments, the scheduling order can refer to the scheduling order of each piece of second data that is scheduled in the next bus scheduling cycle and determined according to the preset scheduling strategy.

Sending each piece of second data to the reception target from the input port of the current bus according to the scheduling order can include sending each piece of second data from the input port of the current bus to the output port of the current bus according to the scheduling order, and sending the at least one piece of second data belonging to the same first data from the output port of the current bus to the corresponding reception target.

In the data processing method of the present disclosure, after the input port of the current bus receives a plurality of pieces of first data, each piece of first data can be split into at least one data unit. Based on the weight information corresponding to each piece of first data, a corresponding number of data units can be determined from each piece of first data as the second data corresponding to the corresponding first data. In the next bus scheduling cycle, each piece of second data can be sent to the reception target from the input port of the current bus according to the scheduling order. Then, on one aspect, compared to performing continuous scheduling on each piece of first data as a whole to cause delays in other pieces of data, in the present disclosure, each piece of first data can be split into a data unit with a small granularity, the bus scheduling can be performed on each piece of first data with the data unit as the unit. Thus, within the same bus scheduling cycle, some data units of the plurality of pieces of first data can be scheduled simultaneously to increase the response frequency to the plurality of pieces of first data. On another aspect, in the present disclosure, based on the weight information corresponding to each piece of first data, the bus scheduling resource occupied by each piece of first data in the next bus scheduling cycle can be determined. Then, the first data with a higher weight can be responded to faster to reduce the scheduling delay for the first data with a higher weight.

In some embodiments, as shown in FIG. 4, the data processing method of the present disclosure includes the following steps S401 to S406.

At S401, the input port of the current bus is configured to receive a plurality of pieces of first data. Each piece of first data has corresponding weight information.

At S402, based on the specified unit data amount, each piece of first data is split into at least one data unit. The unit data amount characterizes the minimum data amount scheduled by the current bus in a single time.

Steps S401 and S402 can correspond to steps S301 and S302 above, respectively. Therefore, for the detailed descriptions of steps S401 and S402, reference can be made to the descriptions of steps S301 and S302 above, and will not be repeated here.

At S403, a total data amount of the data that is sent in the next bus scheduling cycle is determined.

The total data amount of the data sent in the next bus scheduling cycle can be determined based on the bandwidth of the current bus and the data transmission time length within the next bus scheduling cycle.

At S404, based on the weight information corresponding to each piece of first data, the data amount of the second data corresponding to each piece of first data is determined.

The weight information corresponding to each piece of first data can represent the proportion of the bus scheduling resources occupied by the corresponding first data in the next bus scheduling cycle, i.e., a ratio of the scheduled data amount of the corresponding first data in the next bus scheduling cycle to the total data amount.

Based on the weight information corresponding to each piece of first data and the total data amount sent in the next bus scheduling cycle, the data amount of each piece of first data scheduled in the next bus cycle can be determined, i.e., the data amount of the second data corresponding to each piece of first data.

At S405, based on the data amount of each piece of second data, a corresponding number of data units is determined from the corresponding first data as the corresponding second data.

After determining the data amount of each piece of first data scheduled in the next bus scheduling cycle, the at least one data unit of each first data scheduled in the next bus scheduling cycle can be determined according to the data amount of each data unit.

In some embodiments, for each piece of first data, based on the data amount scheduled in the next bus cycle and the data amount of each data unit, a first number of data units scheduled in the next bus cycle can be determined. Based on the reception time of each data unit received by the input port of the current bus, the first number of data units can be determined from the at least one data unit of the first data in a time sequence. The first number of data units can be used as the second data.

In some embodiments, the input port of the current bus can include at least one data buffer. Each data buffer can be implemented as a first-in-first-out (FIFO) queue. Thus, for each piece of first data, the first number of data units can be determined from the FIFO of the input port of the bus.

At S406, in the next bus scheduling cycle, each piece of second data is sent from the input port of the current bus to the reception target according to the scheduling order.

Step S406 can correspond to step S304. Therefore, for detailed descriptions of step

S406, reference can be made to the descriptions of step S304 above, which will not be repeated here.

In the above data processing method, based on the weight information corresponding to each piece of first data, the second data of each piece of first data scheduled in the next bus scheduling cycle can be determined. Thus, the first data with a higher priority can occupy more bus scheduling resources in the next bus scheduling cycle to reduce the scheduling delay of the first data with a higher weight.

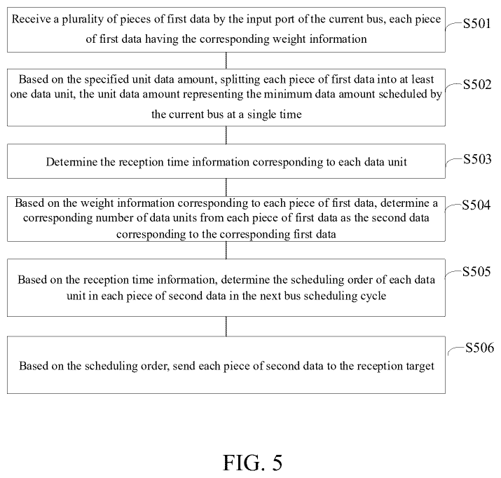

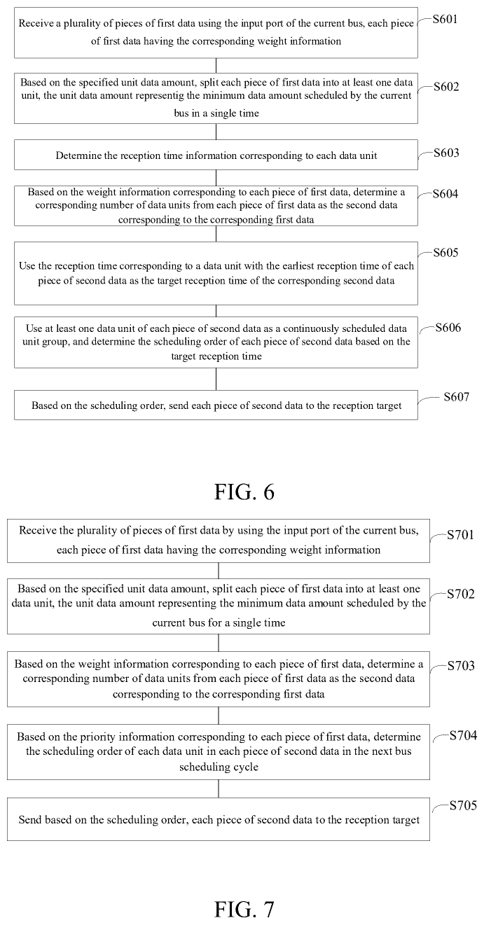

In some embodiments, as shown in FIG. 5, the data processing method of the present disclosure includes the following steps S501 to S506.

At S501, the input port of the current bus is configured to receive a plurality of pieces of first data. Each piece of first data has the corresponding weight information.

At S502, based on the specified unit data amount, each piece of first data is split into at least one data unit. The unit data amount represents the minimum data amount scheduled by the current bus at a single time.

Steps S501 and S502 can correspond to steps S301 and S302, respectively. Therefore, for the detailed descriptions of steps S501 and S502, reference can be made to the above descriptions of steps S301 and S302, which are not repeated here.

At S503, the reception time information corresponding to each data unit is determined.

In some embodiments, the reception time information corresponding to each data unit can be the time when the first byte of each data unit is stored into the buffer of the input port of the current bus, or the time when the last byte of each data unit is stored into the buffer of the input port of the current bus.

At S504, based on the weight information corresponding to each piece of first data, a corresponding number of data units are determined from each piece of first data as the second data corresponding to the corresponding first data.

Step S504 corresponds to step S303. Therefore, for the detailed description of step S504, reference can be made to the description of step S303 above, which is not repeated here.

At S505, based on the reception time information, the scheduling order of each data unit in each piece of second data is determined in the next bus scheduling cycle.

At S506, based on the scheduling order, each piece of second data is sent to the reception target.

After determining the reception time information corresponding to each data unit, the scheduling order within the next bus scheduling cycle can be determined according to the reception time of each data unit.

For example, the second data sent by the fourth host device can include a first data unit and a second data unit. The second data sent by the fifth host device can include a third data unit. The reception time of the first data unit can be earlier than the third data unit. The reception time of the third data unit can be earlier than the second data unit. Thus, in the next scheduling cycle, the scheduling order of the second data corresponding to the fourth host device and the second data corresponding to the fifth host device can be the first data unit, the third data unit, and the second data unit.

In some embodiments, each piece of second data can be used as a continuously scheduled whole. Thus, the scheduling order of each piece of second data in the next bus scheduling cycle can be determined according to the reception time corresponding to each piece of second data.

Thus, the data processing method of the present disclosure can include following steps S601 to S607.

At S601, a plurality of pieces of first data are received using the input port of the current bus. Each piece of first data has the corresponding weight information.

At S602, based on the specified unit data amount, each piece of first data is split into at least one data unit. The unit data amount represents the minimum data amount scheduled by the current bus in a single time.

At S603, the reception time information corresponding to each data unit is determined.

At S604, based on the weight information corresponding to each piece of first data, a corresponding number of data units are determined from each piece of first data as the second data corresponding to the corresponding first data.

Steps S601 to S604 can correspond to steps S501 to S504, respectively. Therefore, for the detailed description of steps S601 to S604, reference can be made to the descriptions of steps S501 to S504 above, which are not repeated here.

At S605, the reception time corresponding to a data unit with the earliest reception time of each piece of second data is used as the target reception time of the corresponding second data.

By using the reception time corresponding to the data unit with the earliest reception time of each piece of second data as the target reception time of the corresponding second data, the earliest data arriving at the input port of the current bus can receive the fastest response.

In some embodiments, the reception time corresponding to a data unit with the latest reception time of each piece of second data can be used as the target reception time of the corresponding second data. Thus, the data, whose reception is completed earliest, can receive the fastest response at the input port of the current bus.

At S606, at least one data unit of each piece of second data is used as a continuously scheduled data unit group. The scheduling order of each piece of second data is determined based on the target reception time.

Each piece of second data can be scheduled as a continuously scheduled data unit group. That is, for each piece of second data, when the second data includes two or more data units, bus scheduling can be performed on the two or more data units in the timely continuous scheduling method in the next bus scheduling cycle.

For example, according to the above embodiment, for the second data corresponding to the fourth host device, the reception time corresponding to the first data unit can be used as the target reception time of the second data. For the second data corresponding to the fifth host device, the reception time information of the third data unit can be used as the target reception time of the second data. Thus, when the scheduling order of the second data corresponding to the fourth host device and the second data corresponding to the fifth host device is determined, since the reception time of the first data unit is earlier than the reception time of the third data unit, the bus scheduling can be performed in the order of the first data unit and the second data unit first, then the third data unit. Then, the second data unit, which originally has a reception time later than the reception time of the third data unit, can be scheduled earlier than the third data unit.

At S607, based on the scheduling order, each piece of second data is sent to the reception target.

Step S607 can correspond to step S506. Therefore, for the detailed description of step S607, reference can be made to the description of step S606 above, which is not repeated here.

In some embodiments, when the reception time of the latest received data unit of each piece of second data is used as the target reception time corresponding to the second data, the target reception time of the second data corresponding to the fourth device can be later than the target reception time of the second data corresponding to the fifth device. Thus, when the scheduling order of the second data corresponding to the fourth host device and the second data corresponding to the fifth host device is determined, the bus scheduling can be performed in the order of the third data unit first, then the first data unit and the second data unit. Thus, the first data unit, which originally has a reception time earlier than the third data unit, can be scheduled later than the third data unit.

In some embodiments, as shown in FIG. 7, the data processing method of the present disclosure includes following steps S701 to S705.

At S701, the plurality of pieces of first data are received by using the input port of the current bus. Each piece of first data has the corresponding weight information.

At S702, based on the specified unit data amount, each piece of first data is split into at least one data unit. The unit data amount represents the minimum data amount scheduled by the current bus for a single time.

At S703, based on the weight information corresponding to each piece of first data, a corresponding number of data units are determined from each piece of first data as the second data corresponding to the corresponding first data.

Steps S701 to S703 can correspond to steps S301 to S303, respectively. Therefore, for the detailed descriptions of steps S701 to S703, reference can be made to the descriptions of steps S301 to S303 above, which are not repeated here.

At S704, based on the priority information corresponding to each piece of first data, the scheduling order of each data unit in each piece of second data is determined in the next bus scheduling cycle.

At S705, based on the scheduling order, each piece of second data is sent to the reception target.

According to the priority information corresponding to the first data, the scheduling order of each data unit in the corresponding second data can be determined within the next bus scheduling cycle. Thus, the first data with a higher priority can receive a faster response.

For example, in some embodiments, when the priority of the first data sent by the fourth host device is higher than the priority of the first data sent by the fifth host device, each data unit in the second data corresponding to the fourth host device can obtain the bus scheduling resources prior than each data unit of the second data corresponding to the fifth host device. That is, the bus scheduling can be performed in the order of the first data unit and the second data unit first, then the third data unit.

Meanwhile, when the scheduling order of each data unit is determined according to the priority information, since each data unit belonging to the same second data has the same priority, each data unit belonging to the same second data can be scheduled continuously as a data unit group.

In some embodiments, in the next bus scheduling cycle, sending each piece of second data sequentially from the input port of the current bus to the reception target according to the scheduling order can include, based on the reception time information of each data unit of each piece of second data, determining the scheduling order of each data unit of each piece of second data in the next bus scheduling cycle. For the at least two data units having the same reception time, based on the priority information, the scheduling order of the at least two data units can be determined.

Thus, when the scheduling order of each data unit of each piece of second data is determined, sorting can be performed first according to the reception time. Then, for the same reception time, sorting can be performed according to the priority information.

For example, in some embodiments, besides the first data unit and the second data unit, the fourth host device can also send a fourth data unit. The reception time of the fourth data unit can be the same as the reception time of the third data unit sent by the fifth host device. Meanwhile, the priority of the first data corresponding to the fourth host device can be higher than the priority of the first data sent by the fifth host device. Thus, when the scheduling order of the first data unit to the fourth data unit is determined, the first data unit that is scheduled earliest can be determined first according to the time sequence. Then, the fourth data unit and the third data unit can have the same reception time, and the priority of the fourth data unit can be higher than the priority of the third data unit. The fourth data unit can be scheduled after the first data unit, and the third data unit can be scheduled after the fourth data unit. Then, the second data unit with the latest reception time can be scheduled.

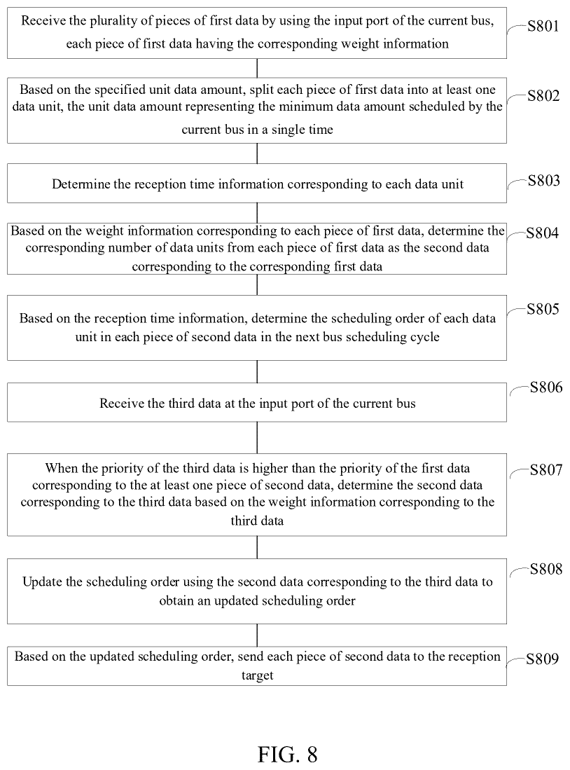

In some embodiments, as shown in FIG. 8, the data processing method of the present disclosure includes following steps S801 to S809.

At S801, the plurality of pieces of first data are received by using the input port of the current bus. Each piece of first data has the corresponding weight information.

At S802, based on the specified unit data amount, each piece of first data is split into at least one data unit. The unit data amount represents the minimum data amount scheduled by the current bus in a single time.

At S803, the reception time information corresponding to each data unit is determined.

At S804, based on the weight information corresponding to each piece of first data, the corresponding number of data units are determined from each piece of first data as the second data corresponding to the corresponding first data.

At S805, based on the reception time information, the scheduling order of each data unit in each piece of second data is determined in the next bus scheduling cycle.

Steps S801 to S805 can correspond to the above steps S501 to S505, respectively. For the detailed descriptions of steps S801 to S805, reference can be made to the above descriptions of steps S501 to S505, which are not repeated here.

At S806, the third data is received at the input port of the current bus.

After the scheduling order of each data unit of each piece of second data in the next bus scheduling cycle is determined, and before the scheduling time of the next bus scheduling cycle, the third data can be received at the input port of the current bus.

The third data can be data sent by the host device or by an upper-level device of the current bus.

The third data can include image data, video data, audio data, text data, or any type of data transmitted via bus in this field.

At S807, when the priority of the third data is higher than the priority of the first data corresponding to the at least one piece of second data, the second data corresponding to the third data is determined based on the weight information corresponding to the third data.

The third data can include corresponding priority information.

In some embodiments, when the priority of the third data is higher than the priority of the first data corresponding to the at least one piece of second data, the weight information corresponding to the third data can be determined based on the priority corresponding to the third data and the priority of the first data corresponding to each piece of second data.

For the description of the method of determining the weight information corresponding to the third data based on the priority of the third data, reference can be made to the above and in connection with the detailed description combined with step S301 above, which is not repeated here.

Based on above, the weight information of the third data can also be determined based on the host device corresponding to the third data, the type of the third data, or the port weight of the input port of the current bus corresponding to the third data, etc.

Thus, based on the weight information corresponding to the third data, the second data corresponding to the third data can be determined. That is, the at least one data unit in the third data scheduled in the next bus scheduling cycle is determined.

For the description of the method for determining the second data corresponding to the third data, reference can be made to the above in connection with the detailed description of steps S302 and S303, which is not repeated here.

At S808, the scheduling order is updated using the second data corresponding to the third data to obtain an updated scheduling order.

The previously determined scheduling order can be updated using the second data corresponding to the third data. That is, the second data corresponding to the third data can be inserted into the previously determined scheduling order to obtain the updated scheduling order.

In some embodiments, the second data corresponding to the third data can replace at least one piece of second data with a priority lower than the priority of the third data in the previously determined scheduling order. In some embodiments, when the data amount of the third data is larger or the priority of the third data is higher, the at least one piece of second data with a lower priority can be removed from the scheduling order to prioritize scheduling the second data corresponding to the third data.

In some embodiments, the second data corresponding to the third data can be used to replace at least one data unit of the at least one piece of second data with a priority lower than the priority of the third data in the previously determined scheduling order. Based on the priority of the third data and the priority of each piece of first data, after re-determining the weight of the third data and the weight of each piece of first data, the data amount of each piece of first data scheduled in the next bus scheduling cycle can be re-determined to cause the at least one data unit of the at least one piece of first data to be removed from the previously determined scheduling order. Moreover, the second data corresponding to the third data can be inserted into the previously determined scheduling order to update the scheduling order.

At S809, based on the updated scheduling order, each piece of second data is sent to the reception target.

Based on the updated scheduling order, when the next bus scheduling cycle arrives, each piece of second data can be sent to the corresponding reception target.

In some embodiments, after determining the scheduling order of the next bus scheduling cycle, if the third data with a higher priority is received, the second data corresponding to the third data can be determined based on the weight corresponding to the third data. The scheduling order can be updated using the second data. Then, the scheduling order can be updated in real-time before the next bus scheduling cycle arrives. Thus, the data with a higher priority can receive a quicker response to further reduce the scheduling delay for the data with a higher priority.

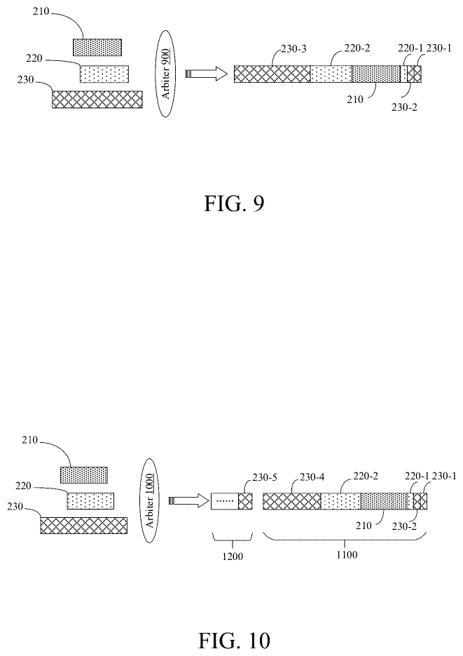

Thus, when in the data processing method of the present disclosure, bus scheduling can be performed on the data 210, data 220, and data 230 sent by the first host device, second host device, and third host device, the scheduling process is shown in FIG. 9. The priority of the data 210 is higher than the priority of the data 220, and the priority of the data 220 is higher than the priority of the data 230.

The data processing method of the present disclosure can be executed by an arbiter 900 of the current bus and can include steps S901 to S904.

At S901, the arbiter 900 performs splitting processes on the data 210, the data 220, and the data 230 arriving at the input port of the current bus, respectively, to obtain a plurality of data units. Then, proceed to step S902.

At S902, according to the priority information corresponding to the data 210, the data 220, and the data 230, the weights corresponding to the data 210, the data 220, and the data 230 are determined, respectively. For example, the weight corresponding to the data 210 is 40%, the weight corresponding to the data 220 is 35%, and the weight corresponding to the data 230 is 25%. Then, proceed to step S903.

At S903, the arbiter 900, according to the weight corresponding to each piece of data, determines the data units of the data 210, the data 220, and the data 230 sent in the next bus scheduling cycle. Then, proceed to step S904.

At S904, the arbiter 900 determines the scheduling order of each data unit in the next bus scheduling cycle according to the reception time information and the priority information of each data unit of the data 210, the data 220, and the data 230.

According to the arrival time, the first data unit 230-1 and the second data unit 230-2 of the data 230 can be received at the earliest. Then, the first data unit 230-1 and second data unit 230-2 of the data 230 can be arranged at the very front of the scheduling order. Then, the data 220 with a higher priority can be received. The sorting of the data units of the data 230 can be interrupted, and the first data unit 220-1 of the data 220 can be used as the next scheduled data unit after the second data unit 230-2. Then, the data 210 with the highest priority can be received. Thus, the sorting of the data 230 and the data 220 with lower priorities can be interrupted, and the data units of the data 210 can be arranged after the first data unit 220-1. Subsequently, the arbiter 400 can sort the remaining data 220-2 of the data 220 and the remaining data 230-3 of the data 230 according to the priorities.

As shown in FIG. 9, the total data amount that can be scheduled in the next bus scheduling cycle is relatively large, and all data units of the data 210, the data 220, and the data 230 can be completely scheduled within the next bus scheduling cycle.

At S905, when the next bus scheduling cycle arrives, the data 210, the data 220, and the data 230 are sent to the reception device.

In some other embodiments, the total data amount that can be scheduled in the next bus scheduling cycle can be relatively small, and the scheduling of all data units of the data 210, the data 220, and the data 230 cannot be completed in the next bus scheduling cycle. Then, a part of the data 230 with a lower priority and smaller weight may need to be scheduled in a next bus scheduling cycle of the next bus scheduling cycle.

As shown in FIG. 10, within the next bus scheduling cycle 1100, the scheduling of the data 210 and the data 220 with higher priorities is completed, and only a part of the data 230 with the lower priority (the first data unit 230-1, the second data unit 230-2, and the data unit group 230-4 including a plurality of data units) is scheduled. Thus, in a next bus scheduling cycle 1200 after the next bus scheduling cycle 1100, the remaining data 230-5 of the data 230 can be scheduled.

The cycle lengths of the bus scheduling cycle 1100 and the bus scheduling cycle 1200 can be schematically illustrated.

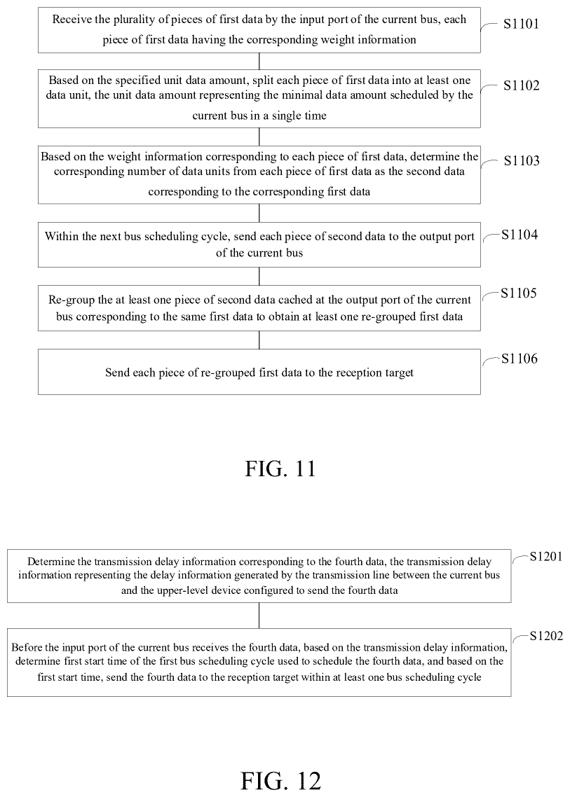

In some embodiments, as shown in FIG. 11, the data processing method of the present disclosure includes following steps S1101 to S1106.

At S1101, the plurality of pieces of first data are received by the input port of the current bus. Each piece of first data has the corresponding weight information.

At S1102, based on the specified unit data amount, each piece of first data is split into at least one data unit. The unit data amount represents the minimal data amount scheduled by the current bus in a single time.

At S1103, based on the weight information corresponding to each piece of first data, the corresponding number of data units are determined from each piece of first data as the second data corresponding to the corresponding first data.

Steps S1101 to S1103 can correspond to steps S301 to S303, respectively. Thus, for the detailed description of steps S1101 to S1103, reference can be made to the above description of steps S301 to S303, which is not repeated here.

At S1104, within the next bus scheduling cycle, each piece of second data is sent to the output port of the current bus.

During the data transmission clock cycle of the next bus scheduling cycle, each piece of second data can be sent to the output port of the current bus.

The data output port of the current bus can include a plurality of data buffers to cache the data scheduled from the input port of the current bus. Meanwhile, each data buffer at the output port can have a correspondence with a data buffer at the input port.

Thus, when at least one piece of second data is scheduled from the input port to the output port within one bus scheduling cycle, the at least one piece of second data can be stored to a corresponding data buffer. Meanwhile, the plurality of pieces of second data belonging to the same first data can be cached in the same data buffer at the output port.

At S1105, the at least one piece of second data cached at the output port of the current bus corresponding to the same first data is re-grouped to obtain at least one re-grouped first data.

For the first data, when all data units corresponding to the first data are cached at the output port of the current bus, that is, the current bus has completed the scheduling of the first data, the at least one data unit belonging to the first data can be re-grouped to obtain the re-grouped first data.

In some embodiments, each data unit can have corresponding identification information. The identification information can be used to indicate the position information of the corresponding data unit in the corresponding first data. Then, based on the identification information corresponding to each data unit, whether the corresponding first data has been completely scheduled can be determined.

At least one piece of second data can be re-grouped. That is, based on the identification information corresponding to each data unit in each piece of second data, each data unit can be re-grouped to obtain the regrouped first data.

At S1106, each piece of re-grouped first data is sent to the reception target.

The current bus can send the re-grouped first data to the corresponding reception target, for example, to the lower-level bus or to the slave device corresponding to the first data.

In some embodiments, after scheduling the at least one piece of second data corresponding to the first data from the input port of the current bus to the output port of the current bus, each data unit in each piece of second data can be re-grouped at the output port to obtain the re-grouped first data, and send the re-grouped first data to the corresponding reception target. Then, when the reception target is the slave device corresponding to the first data, the complete first data can be sent to the slave device. When the reception target is the next level bus device, the complete first data can be sent to the next bus device to cause the next level bus device to be a device configured to perform data scheduling based on any bus scheduling strategy, which is not limited to the data processing method of the present disclosure. That is, the data processing method of the present disclosure can be applied to any single or a plurality of buses. The bus device applying the data processing method of the present disclosure can be used in cooperation with a bus device applying any other bus scheduling strategy to increase the application range of the data processing method of the present disclosure.

In some embodiments, the at least one piece of first data can be fourth data. The fourth data can have a specified bus access frequency.

The fourth data can have a specified bus access frequency, which indicates that the data amount of the fourth data received at the input port of the current bus is fixed per unit time.

In some embodiments, the fourth data can be video access data sent by an Image Signal Processor (ISP), a Data Processing Unit (DPU), etc.

For example, when the fourth data is the video access data sent by the ISP, if 500 frames of image data are sent to the current bus per second, the data amount of the fourth data received within each unit time can be estimated. Thus, the bus scheduling resources can be pre-reserved using the fourth data. When the fourth data arrives at the input port of the bus, the fourth data can be scheduled using the pre-reserved bus scheduling resources to reduce the scheduling delay for the fourth data.

Based on this, as shown in FIG. 12, the data processing method of the present disclosure further includes following steps S1201 and S1202.

At S1201, the transmission delay information corresponding to the fourth data is determined. The transmission delay information represents the delay information generated by the transmission line between the current bus and the upper-level device configured to send the fourth data.

The transmission delay information can be the transmission delay time generated by the transmission path between the current bus and the upper device, i.e., the inherent delay caused by the hardware transmission line.

In some embodiments, the transmission delay information can be the delay information determined during the device verification phase and in the process of performing simulation verification on the current bus and the upper-level device configured to send the fourth data.

Thus, after determining the corresponding transmission line, the transmission delay information corresponding to the fourth data can be determined. For example, when the fourth data is the video access data sent by the ISP, a delay of 100 clock cycles can exist in the physical line between the current bus and the upper-level bus configured to transmit the ISP video access data.

In some embodiments, the upper-level device can be a host device configured to send the fourth data, or an upper-level bus device of the current bus configured to transmit the fourth data.

At S1202, before the input port of the current bus receives the fourth data, based on the transmission delay information, first start time of the first bus scheduling cycle used to schedule the fourth data is determined. Based on the first start time, the fourth data is sent to the reception target within at least one bus scheduling cycle.

When the fourth data is scheduled, the current bus can obtain the start time information of the fourth data sent by the upper-level device from the controller for data transmission control. For example, the host device configured to send the fourth data can start to send the start time information of the fourth data, or the upper-level bus device can schedule the start time information of the fourth data.

Then, before the fourth data is received, the current bus can determine the first start time of the first bus scheduling cycle for scheduling the fourth data, according to the start time and the transmission delay information sent or scheduled by the upper-level device, to pre-reserve the bus scheduling resources for the fourth data.

For example, when the upper-level device is the upper-level bus of the current bus, the upper-level bus starts scheduling the fourth data at Ons. The transmission delay of 130 clock cycles may exist between the upper-level bus and the current bus. Then, the current bus can determine that the first start time of the first bus scheduling cycle for scheduling the fourth data by the current level bus can be the start time of the 130th clock cycle. Thus, the current bus can pre-reserve the bus scheduling resources for the fourth data by using the start time of the 130th clock cycle as the start point. When the fourth data arrives at the current bus through the transmission delay of 130 clock cycles, the current bus can perform the scheduling processing on the fourth data by using the pre-reserved bus scheduling resources.

After the current bus determines the first start time of the first bus scheduling cycle used to schedule the fourth data, since the fourth data has a specified bus access frequency (i.e., a fixed data amount transmitted to the current bus per unit time), the current bus can determine the data amount of the fourth data scheduled in each bus scheduling cycle.

Then, when the fourth data is transmitted to the input port of the current bus, the current bus can start to perform scheduling on the fourth data based on the first start time to send the fourth data to the corresponding reception target within at least one bus scheduling cycle.

In some embodiments, for the fourth data having the specified bus access frequency, the current bus can determine the first start time for scheduling the fourth data based on the transmission delay information corresponding to the fourth data. Then, before the fourth data arrives at the current bus, the bus scheduling resources can be pre-reserved for the fourth data. Thus, before the fourth data arrives at the current bus, the scheduling can be quickly performed to reduce the scheduling delay effect for the fourth data.

In some embodiments, the upper-level device can represent the upper-level bus of the current bus configured to transmit the fourth data. Then, the data processing method can further include steps S1203 and S1204.

At S1203, the first data amount occupied by the fourth data in each bus scheduling cycle of the upper-level bus is determined.

The upper-level bus of the current bus can be a bus device configured to perform the data processing method of the present disclosure. That is, during the process of the upper-level bus scheduling the fourth data, the upper-level bus can split the fourth data into at least one data unit and determine the second data corresponding to the fourth data scheduled within each bus scheduling cycle based on the weight of the fourth data.

Then, to allow the current bus to smoothly transmit the fourth data sent by the upper-level bus, the current bus may need to determine the first data amount occupied by the fourth data within each bus scheduling cycle of the upper-level bus to determine the data amount of the fourth data transmitted within each bus scheduling cycle of the current level bus based on the first data amount.

In some embodiments, the current bus can obtain the first data amount through the communication information with the upper-level bus.

In some embodiments, the current bus can obtain the first data amount through the controller configured to control the bus transmission control.

At S1204, before the input port of the current bus receives the fourth data, the second data amount occupied by the fourth data in each bus scheduling cycle of the current bus is determined. The second data amount is not smaller than the first data amount. Based on the first start time and the second data amount, the fourth data is sent to the reception target within the at least one bus scheduling cycle.

After the first data amount is determined, when the current bus determines the second data amount occupied by the fourth data within each bus scheduling cycle of the current bus, and the second data amount is not smaller than the first data amount, the fourth data can be smoothly transmitted on the current level bus.

Before the fourth data arrives the current bus, the current bus can determine the first start time of the first bus scheduling cycle used to schedule the fourth data, and the second data amount occupied by the fourth data within each scheduling cycle. Then, when the fourth data arrives the current bus, the current bus can assign the corresponding scheduling resources for the fourth data at the preset scheduling time to send the fourth data to the corresponding reception target.

In some embodiments, based on the first data amount occupied by the fourth data in each bus scheduling cycle of the upper-level bus, the current bus can determine the second data amount occupied by the fourth data in each bus scheduling cycle of the current level bus. The second data amount may not be smaller than the first data amount. Thus, the current bus can schedule the fourth data more smoothly.

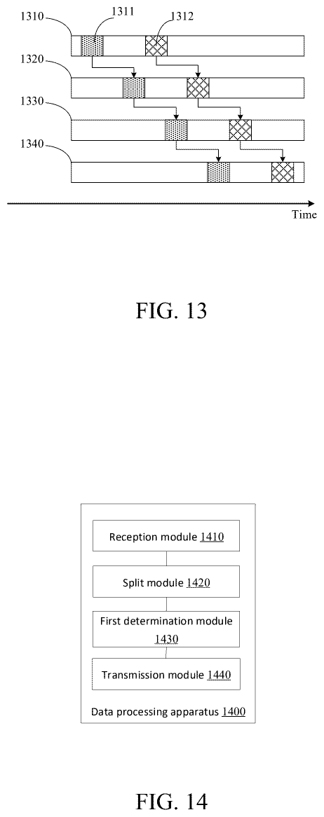

FIG. 13 illustrates a schematic flowchart of bus scheduling in a data processing method according to some embodiments of the present disclosure. As shown in FIG. 13, data sent by a sixth host device 1310 to a corresponding slave device 1340 is scheduled by a first bus 1320 and a second bus 1330. The scheduling process includes the following steps.

The sixth host device 1310 sends the data 1311. The data 1311 is a first portion of data sent by the sixth host device 1310 to the slave device 1340 and is considered as the first data.

After the first bus 1320 receives a bus resource application, the first transmission delay information between the current level bus and the sixth host device 1310, the start transmission time of the sixth host device 1310 sending the data 1311, and the weight corresponding to the data 1311 can be determined. Then, based on the first transmission delay information and the start transmission time and weight of the data 1311, the first bus 1320 can determine the start time of the first bus scheduling cycle for scheduling the data 1311, the data amount occupied by the data 1311 in the first bus scheduling cycle, and pre-reserve the first bus scheduling cycle and the corresponding data amount for the data 1311. When the data 1311 arrives at the input port of the first bus 1320, the first bus 1320 can schedule the data 1311 using the pre-reserved first bus scheduling cycle and the data amount to send the data 1311 to the second bus 1330.

The first bus 1320 can determine the transmission start time of the sixth host device 1310 sending the data 1311 according to the received bus resource application.

The transmission delay between the first bus 1320 and the sixth host device can be determined according to the simulation and verification phase. The first bus 1320 can determine the first transmission delay information.

Based on the priority information of the data 1311 and the priority information of other data that arrives at the first bus 1320 within the same time period with the data 1311, the first bus 1320 can determine the weight of the data 1311, and determine the data amount of the data 1311 sent in one bus scheduling cycle can be determined based on the weight of the data 1311.

As shown in FIG. 13, for example, the first bus 1320 completes the scheduling of all the data unit of the data 1311 within one bus scheduling cycle. When the scheduling of all the data units of the data 1311 cannot be finished within a bus scheduling cycle of the first bus 1320, a portion of data units obtained by splitting the data 1311 can be scheduled within a plurality of bus scheduling cycles of the first bus scheduling cycle.

After the second bus 1330 receives he bus resource application, the second transmission delay information between the current level bus and the first bus 1320 can be determined, and start time of the first bus scheduling cycle of the first bus 1320 scheduling the data 1311 and the data amount occupied by the data 1311 in the first bus scheduling cycle can be determined. Based on the second transmission delay information, the start time of the first bus scheduling cycle, the data amount occupied by the data 1311 in the first bus scheduling cycle, the start time of the second bus scheduling cycle for the current level bus to schedule the data 1311 can be determined, and the data amount occupied by the data 1311 in the second bus scheduling cycle can be determined. The second bus scheduling cycle and the data amount can be pre-reserved for the data 1311. When the data 1311 arrives at the input port of the second bus 1330, the second bus 1330 can schedule the data 1311 using the pre-reserved second bus scheduling cycle and the data amount to send the data 1311 to the slave device 1340.

For the method of the second bus 1330 determining the second transmission delay information and obtaining the start time of the first bus scheduling cycle of the first bus 1320 scheduling the data 1311 and the data amount occupied by the data 1311 in the first bus scheduling cycle, reference can be made to the description above, which is not repeated here.

The sixth host device 1310 can continue to send the data 1312 according to the time sequence and send the data 1312 to the slave device 1340 through the first bus 1320 and the second bus 1330. Then, the scheduling method of the first bus 1320 and the second bus 1330 scheduling the data 1312 can be different from the scheduling method of the first bus 1320 and the second bus 1330 scheduling the data 1311, which are not repeated.

In some embodiments, in the process of scheduling the data 1311 and the data 1312 using the first bus 1320 and the second bus 1330, the first bus 1320 and the second bus 1330 can be configured to pre-reserve the bus scheduling cycle and the data amount occupied by the first data 1311 and the second data 1312 in each bus scheduling cycle for the data 1311 and the data 1312 according to the predicted transmission dely information and the transmission start time and the priority information of the data 1311 and the data 1312. Thus, when arriving at the first bus 1320 and the second bus 1330, the data 1311 and the data 1312 can receive a faster response speed to further reduce the scheduling delay of the data 1311 and the data 1312.

Based on the above, embodiments of the present disclosure further provide a data processing apparatus. The apparatus can include various units and various modules included in the units, which can be implemented by the processor of the computer device or logic circuits. In the implementation, the processor can include a central processing unit (CPU), a microprocessor unit (MPU), a digital signal processor (DSP), or a field programmable gate array (FPGA).

FIG. 14 illustrates a schematic structural diagram of a data processing apparatus according to some embodiments of the present disclosure. As shown in FIG. 14, the data processing apparatus 1400 includes a reception module 1410, a data split module 1420, a first determination module 1430, and a transmission module 1440.

The reception module 1410 can be configured to receive a plurality of pieces of first data at the input port of the current bus. Each first data can include corresponding weight information.

The data split module 1420 can be configured to split each piece of first data into at least one data unit based on the specified unit data amount. The unit data amount can represent the minimal data amount of the current bus in a single scheduling.

The first determination module 1430 can be configured to determine the corresponding number of data units from each piece of first data as the second data corresponding to the corresponding first data based on the weight information corresponding to each piece of first data.

The transmission module 1440 can be configured to send each piece of second data from the input port of the current bus to the reception target within the next bus scheduling cycle.

In some embodiments, the determination module 1430 can be configured to determine the total data amount that can be sent in the next bus scheduling cycle, determine the data amount of the second data corresponding to each piece of first data based on the weight information corresponding to each piece of first data, and determining the corresponding number of the data units from the corresponding first data as the corresponding second data based on the data amount of the each piece of the second data.

In some embodiments, each piece of first data can include the corresponding priority information.

The apparatus 1400 further includes a second determination module 1450.

The second determination module 1450 can be configured to determine the weight information corresponding to each piece of first data based on the priority information corresponding to each piece of first data.

In some embodiments, the apparatus 1400 further includes a third determination module 1460.

The third determination module 1460 can be configured to determine the reception time information corresponding to each of the data units.

The transmission module 1440 further includes a fourth determination module 1441 and a transmission sub-module 1442.

The fourth determination module 1441 can be configured to determine the scheduling order of each data unit of each piece of second data in the next bus scheduling cycle based on the reception time.

The transmission sub-module 1442 can be configured to, based on the scheduling order, send each piece of second data to the reception target.

In some embodiments, the fourth determination module 1441 can be configured to use the reception time corresponding to a data unit having the earliest reception time of each piece of second data as the target reception time of the corresponding second data, use the at least one data unit of each piece of second data as the data unit group that is continuously scheduled, and determine the scheduling sequence of each piece of second data based on the target reception time.

In some embodiments, the transmission module 1440 can be configured to determine the scheduling order of each data unit of each piece of second data in the next bus scheduling cycle based on the priority information corresponding to each piece of first data, and send each piece of second data to the reception target based on the scheduling order.

In some embodiments, after the fourth determination module 1441 determining the scheduling order of each data unit of each piece of second data in the next bus scheduling cycle, the reception module 1410 can be further configured to receive the third data at the input port of the current bus, when the priority of the third data is higher than the priority of the first data corresponding to the at least one piece of second data, determine the second data corresponding to the third data based on the weight information corresponding to the third data, and update the scheduling order using the second data corresponding to the third data to obtain the updated scheduling order. The transmission sub-module 1442 can be configured to send each piece of second data to the reception target based on the updated scheduling order.

In some embodiments, the transmission module 1440 can be configured to send each piece of second data to the output port of the current bus in the next bus scheduling cycle, re-group the at least one second data corresponding to the same first data cached at the output port of the current bus, and send the each piece of re-grouped first data to the reception target.

In some embodiments, the at least one piece of first data can be the fourth data. The fourth data can have a specified bus access frequency.

The apparatus 1400 can further include a fifth determination module 1460 and a sixth determination module 1470.

The fifth determination module 1460 can be configured to determine the transmission delay information corresponding to the fourth data. The transmission delay information can represent the delay information generated by the transmission line between the current bus and the upper-level device configured to send the fourth data.

The sixth determination module 1470 can be configured to, before the input port of the current bus receives the fourth data, determine the first start time of the first bus scheduling cycle used to schedule the fourth data based on the transmission delay information.

The transmission module 1440 can be configured to send the fourth data to the reception target within the at least one bus scheduling cycle based on the first start time.

In some embodiments, the upper-level device can represent the upper-level bus of the current bus configured to transmit the fourth data.

The transmission module 1440 can be configured to determine the first data amount occupied by the fourth data in each bus scheduling cycle of the upper-level device, determine the second data amount occupied by the fourth data in each bus scheduling cycle of the current bus, the second data amount being equal to or greater than the first data amount, and send the fourth data to the reception target in the at least one bus scheduling cycle based on the first start time and the second data amount.

The description of the apparatus embodiments is similar to the description of the method embodiments and has the similar beneficial effects as the method embodiments. In some embodiments, the functions or modules included in the apparatus of embodiments of the present disclosure can be used to execute the methods described in the method embodiments above. For technical details not disclosed in the apparatus embodiments of the present disclosure, reference can be made to the descriptions of the method embodiments of the present disclosure.

In embodiments of the present disclosure, if the data processing method is implemented in the form of software functional modules and sold or used as an independent product, the data processing method can also be stored in a computer-readable storage medium. Based on such an understanding, the technical solutions of embodiments of the present disclosure can essentially be embodied as a software product, stored in a storage medium, and include several instructions to make a computer device (e.g., a personal computer, server, or network device, etc.) execute all or a part of the steps of the methods described in various embodiments of the present disclosure. The storage medium can include a USB flash drive, a mobile hard drive, read-only memory (ROM), magnetic disks, optical disks, and other media that can store program codes. Therefore, embodiments of the present disclosure are not limited to any specific hardware, software, firmware, or any combination of hardware, software, and firmware.

Embodiments of the present disclosure provide a computer device, including a memory and a processor. The memory stores a computer program executable on the processor that, when executed by the processor, causes the processor to implement a part or all of the steps in the above methods.

Embodiments of the present disclosure provide a computer-readable storage medium storing a computer program that, when executed by the processor, causes the processor to implement a part or all of the steps in the above methods. The computer-readable storage medium can be transient or non-transient.

Embodiments of the present disclosure provide a computer program including computer-readable codes that, when running in a computer device, cause the processor of the computer device to implement a part or all of the steps in the above methods.

Embodiments of the present application provide a computer program product including a non-transitory computer-readable storage medium storing a computer program that, when read and executed by the computer, causes the computer to implement a part or all of the steps in the above method. The computer program product can be implemented by hardware, software, or a combination thereof. In some embodiments, the computer program product can be embodied as a computer storage medium. In other embodiments, the computer program product can be embodied as a software product, for example, a software development kit (SDK), etc.

The description of embodiments of the present disclosure tends to emphasize the differences between various embodiments, and same or similar places can be referred to each other. The description of the device, storage medium, computer program, and computer program product embodiments can be similar to the method embodiments and have beneficial effects similar to the method embodiments. For the technical details not disclosed in the device, storage medium, computer program, and computer program product embodiments of the present disclosure, reference can be made to the description of the method embodiments of the present disclosure.

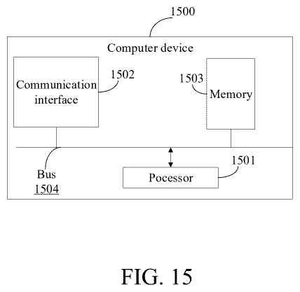

FIG. 15 illustrates a schematic diagram showing hardware of a computer device 1500 according to some embodiments of the present disclosure. As shown in FIG. 15, the hardware entity of the computer device 1500 includes a processor 1501, a communication interface 1502, and a memory 1503.

The processor 1501 can be generally configured to control the overall operation of the computer device 1500.

The communication interface 1502 can enable the computer device to communicate with other terminals or servers through the network.

The memory 1503 can be configured to store instructions and applications executable by the processor 1501, and can also cache data to be processed or already processed by the processor 1501 and each module in the computer device 1500 (for example, image data, audio data, voice communication data, and video communication data), which can be realized by flash memory (FLASH) or random access memory (RAM). The processor 1501, communication interface 1502, and memory 1503 can perform data transmission via a bus 1504.

Throughout the specification, the terms “an embodiment” or “one embodiment” mean that a particular feature, structure, or characteristic related to embodiments of the present disclosure can be included in at least one embodiment of the present disclosure. Thus, the term “in an embodiment” or “in one embodiment” throughout the specification do not necessarily refer to the same embodiment. Moreover, the particular features, structures, or characteristics can be combined in any suitable manner in one or more embodiments. In various embodiments of the present disclosure, the size of the serial numbers of the above steps/processes does not mean that the execution order, and the execution order of the steps/processes are determined according to functions and inherent logic, and should not limit the implementation process of embodiments of the present disclosure. The serial numbers of embodiments of the present disclosure are merely for description and do not represent the merit of embodiments of the present disclosure.

In the present specification, the terms “include,” “comprise,” or any other variant thereof are intended to cover non-exclusive inclusion, so that a process, method, article, or apparatus that includes a serial of elements not only include those elements but may also include other elements not explicitly listed, or also include elements inherent to such a process, method, article, or apparatus. When there are no more restrictions, an element defined by the phrase “including a . . . ” does not exclude the presence of other identical elements in the process, method, article, or apparatus that includes the element.

In several embodiments of the present disclosure, the disclosed devices and methods can be realized in other ways. The device embodiments described above are merely illustrative, for example, the division of units can only be a logical functional division. In actual implementation, other division manners can be provided. For example, a plurality of units or components can be combined, or can be integrated into another system, or some features can be ignored or not executed. Moreover, the coupling, direct coupling, or communication connection between the respective components displayed or discussed can be an indirect coupling or communication connection between the devices, or units via some interfaces, which can be electrical, mechanical, or other forms.

The units described as separate parts above can be, or may not be, physically separated. The components displayed as units can be, or may not be, physical units. The components can be located in one place or distributed to a plurality of network units. A part or all of the units can be selected according to actual needs to achieve the purpose of the technical solution of embodiments of the present disclosure.

In addition, the functional units of embodiments of the present disclosure can be integrated into one processing unit, or the units can be independently used as a single unit. Alternatively, two or more units can be integrated into one unit. The integrated unit can be implemented by hardware, or can be implemented by a combination of hardware and software functional units.

Those skilled in the art can understand that the full or partial steps of the method embodiments can be implemented by a program instructing related hardware. The program can be stored in a computer-readable storage medium. When the program is executed, the steps of the method embodiments can be performed. The storage medium can include mobile storage devices, read-only memory (ROM), disks, optical disks, or other media capable of storing program codes.

Alternatively, the above-integrated units in the present disclosure, if implemented as software functional modules and sold or used as independent products, can also be stored in a computer-readable storage medium. Based on such understanding, the technical solution of the present disclosure essentially or the part contributing to the related technology can be embodied in the form of a software product, which is stored in a storage medium, including several instructions for making a computer device (e.g., a personal computer, server, or network device, etc.) execute all or a part of the methods described in embodiments of the present disclosure. The storage medium can include mobile storage devices, ROM, disks, optical disks, or other media capable of storing program codes.

The above are merely embodiments of the present disclosure. However, the scope of the present disclosure is not limited to this. Those skilled in the art can easily think of modifications or replacements within the scope of the present disclosure. Those modifications or replacements are within the scope of he present disclosure.

What is claimed is:

1. A data processing method, comprising:
receiving a plurality of pieces of first data using an input port of a current bus, each piece of first data including corresponding weight information;
based on a specified unit data amount, splitting each piece of first data into at least one data unit, the unit data amount representing a minimum data amount of a single scheduling of the current bus;
based on the weight information corresponding to each piece of first data, determining a corresponding number of data units from each piece of first data as second data corresponding to corresponding first data; and
in a next bus scheduling cycle, sequentially sending each piece of second data from the input port of the current bus to a reception target according to a scheduling order.

2. The method according to claim 1, wherein, based on the weight information corresponding to each piece of first data, determining the corresponding number of data units from each piece of first data as the second data corresponding to the corresponding first data includes:
determining a total data amount that is able to be sent in the next bus scheduling cycle;
based on the weight information corresponding to each piece of first data, determining a data amount of the second data corresponding to each piece of first data; and
based on a data amount of each piece of second data, determining the corresponding number of data units from the corresponding first data as the corresponding second data.

3. The method according to claim 1,
wherein each piece of first data has corresponding priority information;
the method further comprising, based on the priority information corresponding to each piece of first data, determining the weight information corresponding to each piece of first data.

4. The method according to claim 3, further comprising, after splitting each piece of first data into the at least one data unit based on the specified unit data amount:
determining reception time information corresponding to each data unit; and
in the next bus scheduling cycle, sequentially sending each piece of second data from the input port of the current bus to the reception target according to the scheduling order including:
based on the reception time information, determining a scheduling order of each data unit of each piece of second data within the next bus scheduling cycle; and
based on the scheduling order, sending each piece of second data to the reception target.

5. The method according to claim 4, wherein, based on the reception time information, determining the scheduling order of each data unit in each piece of second data within the next bus scheduling cycle, includes:
using reception time corresponding to a data unit with an earliest reception time in each piece second data as a target reception time of the corresponding second data; and
using the at least one data unit in each piece of second data as a data unit group that is continuously scheduled, and determining the scheduling order of each piece of second data based on the target reception time.

6. The method according to claim 5, wherein, in the next bus scheduling cycle, sequentially sending each piece of second data from the input port of the current bus to the reception target according to the scheduling order includes:
based on the priority information corresponding to each piece of first data, determining the scheduling order of each data unit of each piece of second data within the next bus scheduling cycle; and
based on the scheduling order, sending each piece of second data to the reception target.

7. The method according to claim to 6, further comprising, after determining the scheduling order of each data unit of each piece of second data within the next bus scheduling cycle:
receiving third data at the input port of the current bus;
when a priority of the third data is higher than a priority of at least one piece of second data corresponding to the first data, based on the weight information corresponding to the third data, determining second data corresponding to the third data;
updating the scheduling order using the second data corresponding to the third data to obtain an updated scheduling order; and
based on the scheduling order, sending each piece of second data to the reception target, including:
based on the updated scheduling order, sending each piece of second data to the reception target.

8. The method according to claim 1, wherein, in the next bus scheduling cycle, sending each piece of second data to the reception target includes:
in the next bus scheduling cycle, sending each piece of second data to an output port of the current bus;
re-grouping the at least one piece of second data cached at an output port of the current bus and corresponding to the same first data, to obtain at least one re-grouped first data; and
sending each piece of re-grouped first data to the reception target.

9. The method according to claim 1,
wherein, at least one piece of first data is fourth data, and the fourth data has a specified bus access frequency within the bus scheduling cycle;
the method further comprising:
determining transmission delay information corresponding to the fourth data, the transmission delay information representing delay information generated by a transmission line between the current bus and an upper-level device configured to send the fourth data; and
before receiving the fourth data at the input port of the current bus, based on the transmission delay information, determining first start time of the first bus scheduling cycle for scheduling the fourth data to, based on the first start time, send the fourth data to the reception target within at least one bus scheduling cycle.

10. The method according to claim 9,
wherein the upper-level device represents the upper-level bus of the current bus configured to transmit the fourth data;
the method further comprising:
determining a first data amount occupied by the fourth data in each bus scheduling cycle of the upper-level bus; and
before receiving the fourth data at the input port of the current bus, determining a second data amount occupied by the fourth data in each bus scheduling cycle of the current bus, the second data amount being not less than the first data amount, and based on the first start time and the second data amount, the fourth data being sent to the reception target within at least one bus scheduling cycle.

11. A data processing apparatus, comprising:
a reception module configured to receive a plurality of first data at an input port of a current bus; each piece of first data has corresponding weight information;
a data splitting module configured to, based on a specified unit data amount, split each piece of first data into at least one data unit, the unit data amount representing a minimum data amount of the current bus in a single scheduling;
a first determining module configured to, based on each the weight information corresponding to each piece of first data, determining a corresponding number of data units from each piece of first data as second data corresponding to the corresponding first data; and
a transmission module configured to sequentially send each piece of second data to a reception target from the input port of the current bus according to a scheduling order in a next bus scheduling cycle.

12. A non-transitory computer-readable storage medium storing a program that, when executed by a processor, causes the processor to:
receive a plurality of pieces of first data using an input port of a current bus, each piece of first data including corresponding weight information;
based on a specified unit data amount, split each piece of first data into at least one data unit, the unit data amount representing a minimum data amount of a single scheduling of the current bus;
based on the weight information corresponding to each piece of first data, determine a corresponding number of data units from each piece of first data as second data corresponding to corresponding first data; and
in a next bus scheduling cycle, sequentially send each piece of second data from the input port of the current bus to a reception target according to a scheduling order.

13. The storage medium according to claim 12, wherein the processor is further configured to:
determine a total data amount that is able to be sent in the next bus scheduling cycle;
based on the weight information corresponding to each piece of first data, determine a data amount of the second data corresponding to each piece of first data; and
based on a data amount of each piece of second data, determine the corresponding number of data units from the corresponding first data as the corresponding second data.

14. The storage medium according to claim 12, wherein:
each piece of first data has corresponding priority information; and
the processor is further configured to, based on the priority information corresponding to each piece of first data, determine the weight information corresponding to each piece of first data.

15. The storage medium according to claim 15, wherein the processor is further configured to:
determine reception time information corresponding to each data unit; and
in the next bus scheduling cycle, sequentially send each piece of second data from the input port of the current bus to the reception target according to the scheduling order including:
based on the reception time information, determining a scheduling order of each data unit of each piece of second data within the next bus scheduling cycle; and
based on the scheduling order, sending each piece of second data to the reception target.

16. The storage medium according to claim 15, wherein the processor is further configured to:
use reception time corresponding to a data unit with an earliest reception time in each piece of second data as a target reception time of the corresponding second data; and
use the at least one data unit in each piece of second data as a data unit group that is continuously scheduled, and determine the scheduling order of each piece of second data based on the target reception time.

17. The storage medium according to claim 16, wherein the processor is further configured to:
based on the priority information corresponding to each piece of first data, determine the scheduling order of each data unit of each piece of second data within the next bus scheduling cycle; and
based on the scheduling order, send each piece of second data to the reception target.

18. The storage medium according to claim 17, wherein the processor is further configured to:
receive third data at the input port of the current bus;
when a priority of the third data is higher than a priority of at least one piece of second data corresponding the first data, based on the weight information corresponding to the third data, determine second data corresponding to the third data;
update the scheduling order using the second data corresponding to the third data to obtain an updated scheduling order; and
based on the scheduling order, send each piece of second data to the reception target, including:
based on the updated scheduling order, send each piece of second data to the reception target.

19. The storage medium according to claim 12, wherein the processor is further configured to:
in the next bus scheduling cycle, send each piece of second data to an output port of the current bus;
re-group the at least one piece of second data cached at an output port of the current bus and corresponding to the same first data, to obtain at least one re-grouped first data; and
send each piece of re-grouped first data to the reception target.

20. The storage medium according to claim 12, wherein:
at least one piece of first data is fourth data, and the fourth data has a specified bus access frequency within the bus scheduling cycle;
the processor is further configured to:
determine transmission delay information corresponding to the fourth data, the transmission delay information representing delay information generated by a transmission line between the current bus and an upper-level device configured to send the fourth data; and
before receiving the fourth data at the input port of the current bus, based on the transmission delay information, determine first start time of the first bus scheduling cycle for scheduling the fourth data to, based on the first start time, send the fourth data to the reception target within at least one bus scheduling cycle.
